(19) United States
(12) Patent Application Publication
(10) Pub. No.: US 2016/0344213 A1
(43) Pub. Date: Nov. 24, 2016

(54) Battery phone charger able to charge phones or tablets while walking on the road

(71) Applicant: GODFREY CHUKUMA IWU, PIKESVILLE, MD (US)

(72) Inventor: GODFREY CHUKUMA IWU, PIKESVILLE, MD (US)

(21) Appl. No.: 14/715,356

(22) Filed: May 18, 2015

(51) Int. Cl. H02J 7/00

(52) U.S. Cl. CPC H02J 7/0044

(57) ABSTRACT

A battery cell phone and tablet charger that gives user the ability to charge phone and tablets while walking on the road, jugging, sitting in the bus or bus stop, in the train or train station. The said Invention can be charged with an adapter that goes into the power outlet and charged overnight and is able to retain power for three (3) days. The said Invention has a hole for a USB CAR CHARGER for charging phones and tablets which also can be capped off when not in use. The said Invention has a red light to indicate when the said Invention is running out of charge and a green light also to indicate that it is fully charged.

### BRIEF DESCRIPTION OF THE DRAWING

FIG. 1 is a prospective view of said Invention which is said to comprise a hole for a USB CAR CHARGER in THE upper part of said Invention.

FIG. 2, a small hole of a charging port for an adapter which allows user the chance to charge said BATTERY PHONE CHARGER.

FIG. 3 a red light that indicates when the said Invention is running out and ready for charge.

FIG. 4 a green light that indicates that the said Invention is fully charged and is ready for user.

FIG. 5 the said Invention also has a cap to cap it off when not in use.

### DETAILED DESCRIPTION

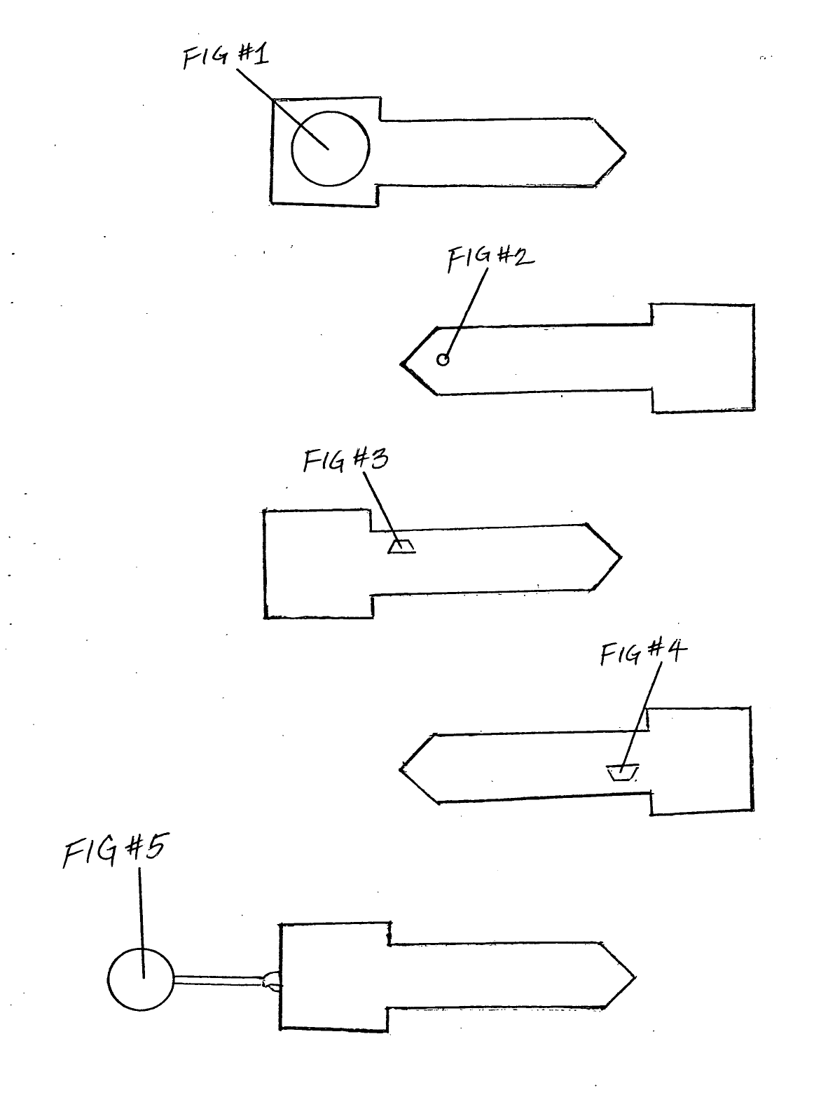

FIG. 1 is a perspective view of the upper part of said Invention of a BATTERY PHONE CHARGER and has a circumferential hole that fits the USB CAR CHARGER

FIG. 2 shows the upper part of said Invention and a hole to plug-in an adapter for charging the said Invention of a BATTERY PHONE CHARGER. And its plugged into an electrical outlet for charging.

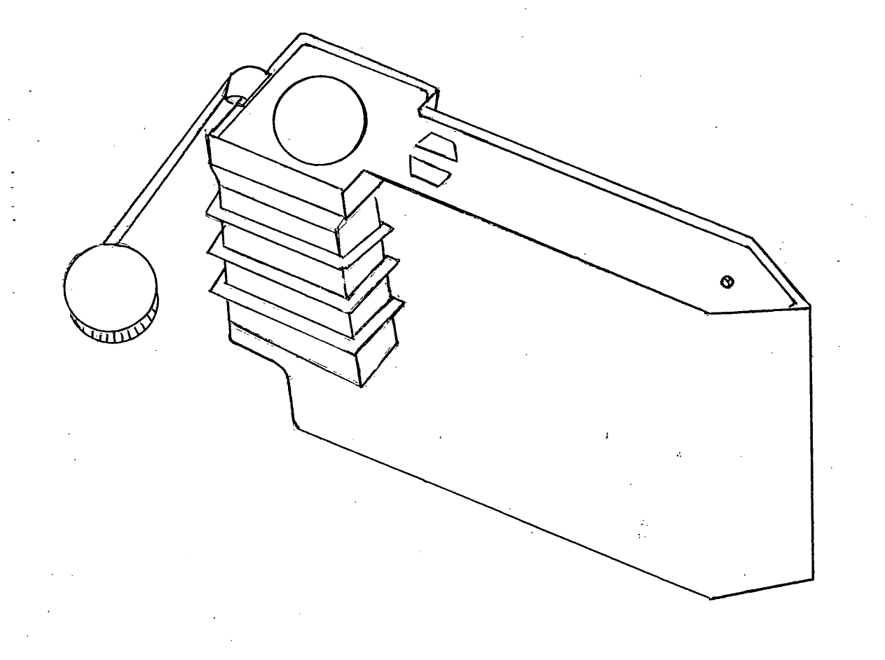

FIG. 3 a red light shows when the said Invention is discharging and not able to go on again.

FIG. 4 a green light also indicate when the said BATTERY PHONE CHARGER is fully charged and ready to go on again.

FIG. 5 is a cap to cap-off the said Invention so that no object falls into it.

### Goal

This relate to a BATTERY PHONE CHARGER specifically Invented having means of helping user of said Invention to charge cell phone or tablet while walking along the road, in the bus stop, in the train or even jugging.

A phone user can charge a phone in an outlet at home only to discover the phone was not properly charged and while talking on the road, the phone discharges, the user has no other alternative than to pocket phone till he or she gets home.

### Operation

In operation a user uses the said Invention of a battery phone charger to charge cell phones or tablets on a USB CAR CHARGER while walking along the road, jugging, or waiting for the bus and even in the bus stop in the train and train station. Cell phones can be very disappointing specially when a cell phone user is talking and all of a sudden the phone shuts off and user of phone still has a lot of people to call, user have no choice but to pocket phone till he or she gets home but with the said BATTERY PHONE CHARGER, user has to simply connect phone to the said invention and continue talking.

### BRIEF SUMMERY OF THE INVENTION

A BATTERY PHONE CHARGER that has a hole for a USB CAR CHARGER at the upper left side for charging phones or tablets the phone charger is capped off when not in use. In addition, this provides the charging ability for the user to charge phone or tablet while on the go. A red light indicates that the said charger is discharging while the green light on the said charger indicates the said phone or tablet charger is fully charged.

What is claimed:

1. A battery phone charger, comprising:
Whereby (a) a user of said Invention can plug-in phone using a USB CAR CHARGER into the said BATTERY PHONE CHARGER and said Invention can be placed inside a hand bag. The said Invention of a BATTERY PHONE CHARGER weighs 1 ib, and measures 3¼ in the width, 5 ins in length and 3.½ ins height. The upper side of said Invention that also has the hole measures 1 in Square.
The user of said Invention of a BATTERY PHONE CHARGER can charge phone while (A) walking along the road side, (B) waiting for the bus, (C) while in the bus, (D) jugging, (E) on the train or in the train station and doing all sorts of things.
The said Invention of a BATTERY PHONE CHARGER is said to help users that talks too much on the phone while away from home and there is no more things like: OH MY PHONE IS RUNNING OUT OF CHARGE, I'LL CALL YOU WHEN I GET HOME. A user can plug in the USB CAR CHARGER, plug in phone and continue talking.
